(19) United States
(12) Patent Application Publication
(10) Pub. No.: US 2024/0407336 A1
(43) Pub. Date: Dec. 12, 2024

(54) Harness for an Animal

(71) Applicant: Yeu Hoon YUN, South Pasadena, CA (US)

(72) Inventor: Yeu Hoon YUN, South Pasadena, CA (US)

(21) Appl. No.: 18/207,029

(22) Filed: Jun. 7, 2023

(51) Int. Cl. A01K 27/00

(52) U.S. Cl. CPC A01K 27/002

(57) ABSTRACT

A harness for an animal presented herein has a front strap, a rear strap forming a closed loop and a link connecting the upper section of the front strap and the upper section of the rear strap.

The front strap has a right extension and a left extension. A portion of the right extension wraps around a torso of the animal to connect to the closed loop when used on the animal, and a portion of the left extension also wraps around the torso of the animal, crossing over or under the right extension and connect to the closed loop when used on the animal. A right tab and a left tab are attached to the closed loop so that the right extension attaches to the left tab and the left extension attaches to the right tab.

### SUMMARY

A harness for an animal is presented herein.

Various forms of animal restraints for walking pets are available in the market. Some restraints use neck collars and some restraints use harnesses. The neck collars are generally simple but chokes the animal when the restraint is applied. For example, when a leash is attached to the neck collar, the pulling on the leash restrains the animal but the restrain unfortunately chokes the animal. On the other hand, a harness used to wrap around the torso of the animal does not choke the animal, but the harness is fixed in length so the animal is uncomfortable and binding to the animal when the harness is worn.

Therefore, there is a need for a harness for an animal that would loosen the hold around the torso of the animal when not pulled (that is, when a restraint is not applied), but would tighten and securely hold the animal around the torso when pulled (that is, when a restraint is applied.) The harness for an animal described herein solves the problems described above by incorporating a closed loop into the harness that adjusts flexibly to loosen the grip around the torso when not pulled upon and tightens the grip around the torso when pulled upon.

A harness for an animal presented herein has a front strap, a rear strap forming a closed loop and a link connecting the upper section of the front strap and the upper section of the rear strap.

The link may be in the form of a strap. In fact, a strap may be a cord, a leather or corded strip or band, a flattened string, denim, fabric, nylon, flexible plastic, string, and other strapping means used in harnesses for animals.

The front strap has a right extension and a left extension such that a portion of the right extension wraps around a torso of the animal to connect to the closed loop when used on the animal, and a portion of the left extension also wraps around the torso of the animal, crossing over or under the right extension and connect to the closed loop when used on the animal. A right tab and a left tab are attached to the closed loop so that the right extension attaches to the left tab and the left extension attaches to the right tab.

When the harness is on the animal, the right extension of the front strap extends from the upper section of the front strap, covering over a section between a throat and a right front leg of the animal and continuing to wrap around the torso of the animal to connect to the left tab when used on the animal. Also, when the harness is on the animal, the left extension extends from the upper section of the front strap, covering over a section between the throat and a left front leg of the animal and continues to wrap around the torso of the animal to connect to the right tab when used on the animal. A portion of the right extension wraps around the torso of the animal and a portion of the left extension wraps around the torso of the animal, the right extension and the left extension cross over each other, forming an “X” shape, over a sternum of the animal.

The right tab and the left tab are slidably attached to the closed loop so that either or both the right tab and the left tab slide along the closed loop. The right tab has a right tab opening and the left tab has a left tab opening so that the rear strap forming the closed loop is inserted through both the right tab opening and the left tab opening so that either or both the right tab and the left tab easily slide along the closed loop.

The closed loop is flexible. The flexible loop is thus able to have a varying loop width and a varying loop height. When a leash attached to the closed loop is not pulled tight, the closed loop is relaxed and the closed loop flattens, making the loop width wider (making the loop height shorter), making the entire harness loosely fit on the animal. When the leash attached to the closed loop is pulled tight, the closed loop is pulled and the closed loop elongates towards the pulling force, making the loop width narrower (making the loop height longer), making the entire harness tightly fit on the animal.

Because the closed loop is relaxed and as the closed loop 30 flattens, making the loop width wider (making the loop height shorter), when the leash is not pulled, the harness is relaxedly fit over the animal and the harness hardly put any binding force on the animal, making the animal comfortable. However, when the leash is pulled, the closed loop is pulled and the closed loop elongates towards the pulling force, making the loop width narrower (making the loop height longer), making the entire harness tightly fit on the animal, pulling on the lower torso or on the sternum of the animal and the shoulders of the animal, controlling and restraining the animal without choking the animal. Moreover, because the pulling force is distributed over the shoulders and over the lower torso (or over the sternum), the pulling force is well distributed over the animal's body, minimizing any choking or any of the straps digging into the body of the animal due to the pressure concentrated at any one point.

To better accommodate the leash, a ring is attached to the link or to the loop so that a leash can be attached to the ring. One embodiment has the link with a hole formed at an end of the link, away from the front strap and next to the closed loop. A part of the ring is inserted through the hole and the ring is free to rotate about the hole.

Various versions of the harness are available. An embodiment of the harness for an animal has a right strap attached to the right extension and a left strap attached to the left extension. In this embodiment, a portion of the right extension wraps around a torso of the animal and the right strap attached to the right extension is removably attached to the left tab, and a portion of the left extension wraps around the torso of the animal, crossing over or under the right extension, and the left strap attached to the left extension is removably attached to the right tab.

An embodiment of the harness for an animal has the right strap with a right buckle used to adjust length of the right strap and the left strap with a left buckle used to adjust length of the left strap. The right buckle and the left buckle are used to adjust the harness to comfortably fit the animal.

A harness for an animal is presented, and it is better described, together with the drawings and detailed description below.

### BRIEF DESCRIPTION OF THE DRAWINGS

These and other features, aspects, and advantages of the harness for an animal will become better understood with reference to the accompanying drawings, wherein:

FIG. 1 is an isometric view of the harness for an animal,

FIG. 2 is a top view of the harness for an animal,

FIG. 3 is a rear view of the harness for an animal,

FIG. 4 is the harness for an animal worn by a pet, and

FIG. 5 is another view of the harness for an animal worn by a pet.

### DETAILED DESCRIPTION

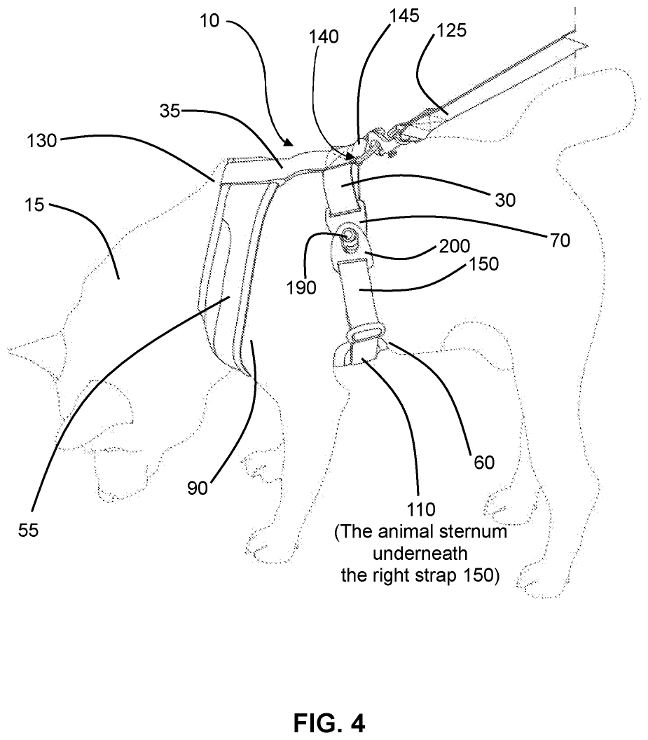

A harness 10 for an animal 15 is described in FIGS. FIG. 4 shows the harness 10 for an animal 15 as worn by a pet, a dog.

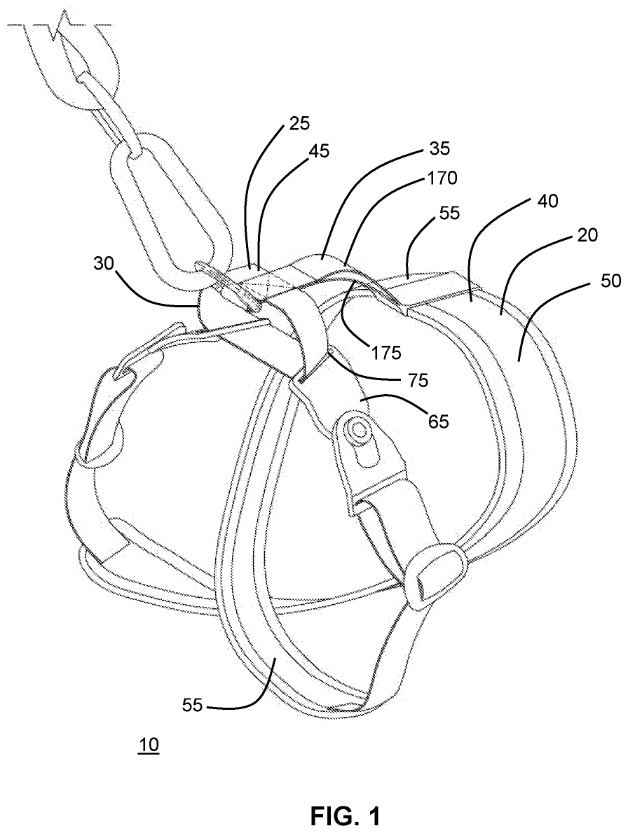

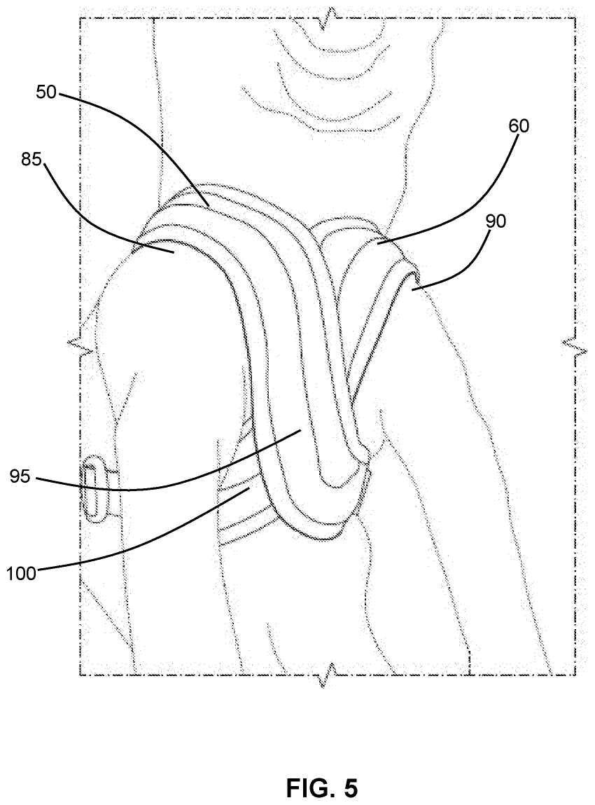

As shown in FIGS. 1 and 5, the harness 10 for an animal presented herein has a front strap 20, a rear strap 25 forming a closed loop 30 and a link 35 connecting the upper section of the front strap 40 and the upper section of the rear strap 45. The link 35 may be in the form of a strap. In fact, a strap may be a cord, a leather or corded strip or band, a flattened string, denim, fabric, nylon, flexible plastic, string, and other strapping means used in harnesses for animals.

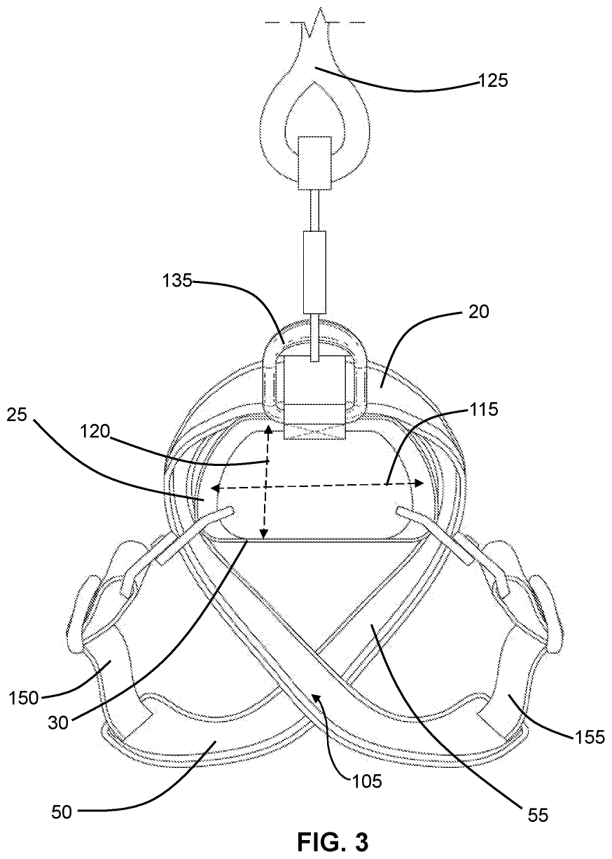

FIGS. 1-5 show the front strap 20 has a right extension 50 and a left extension 55 such that a portion of the right extension 50 wraps around a torso 60 of the animal to connect to the closed loop 30 when used on the animal, and a portion of the left extension 55 also wraps around the torso 60 of the animal, crossing over or under the right extension 50 and connect to the closed loop 30 when used on the animal.

A right tab 65 and a left tab 70 are attached to the closed loop 30 so that the right extension 50 attaches to the left tab 70 and the left extension 55 attaches to the right tab 65. The right tab 65 and the left tab 70 are slidably attached to the closed loop 30 so that either or both the right tab 65 and the left tab 70 slide along the closed loop 30. The right tab 65 has a right tab opening 75 and the left tab 70 has a left tab opening 80 so that the rear strap 25 forming the closed loop 30 is inserted through both the right tab opening 75 and the left tab opening 80 so that either or both the right tab 65 and the left tab 70 easily slide along the closed loop 30. To best accommodate the rear strap 25 forming a closed loop 30, the right tab opening and the left tab opening are shaped as elongated slits.

When the harness 10 is on the animal, the right extension 50 of the front strap 20 extends from the upper section of the front strap 40, covering over a section between a throat and a right front leg 85 of the animal 15 and continuing to wrap around the torso 60 of the animal 15 to connect to the left tab 70 when used on the animal 15. Also, when the harness 10 is on the animal 15, the left extension 55 extends from the upper section of the front strap 40, covering over a section between the throat and a left front leg 90 of the animal 15 and continues to wrap around the torso 60 of the animal 15 to connect to the right tab 65 when used on the animal 15. A portion of the right extension 95 wraps around the torso 60 of the animal 15 and a portion of the left extension 100 wraps around the torso 60 of the animal 15, the right extension 50 and the left extension 55 cross over each other, forming an “X” shape 105, over a sternum 110 of the animal 15.

The closed loop 30 formed by the rear strap 25 is flexible. The flexible closed loop 30 is thus able to have a varying loop width 115 and a varying loop height 120. When a leash 125 attached to the closed loop 30 is not pulled tight, the closed loop 30 is relaxed and the closed loop 30 flattens, making the loop width 115 wider (making the loop height 120 shorter), making the entire harness loosely fit on the animal 15. When the leash 125 attached to the closed loop is pulled tight, the closed loop 30 is pulled and the closed loop 30 elongates towards the pulling force, making the loop width 115 narrower (making the loop height 120 longer), making the entire harness 10 tightly fit on the animal 15.

Because the closed loop 30 is relaxed and as the closed loop 30 flattens, making the loop width 115 wider (making the loop height shorter), when the leash 125 is not pulled, the harness 10 is relaxedly fit over the animal and the harness hardly put any binding force on the animal 10, making the animal comfortable. However, when the leash 125 is pulled, the closed loop 30 is pulled and the closed loop 30 elongates towards the pulling force, making the loop width 115 narrower (making the loop height 120 longer), making the entire harness 10 tightly fit on the animal 15, pulling on the lower torso 60 or on the sternum 110 of the animal 15 and the shoulders 130 of the animal, controlling and restraining the animal 15 without choking the animal 15. Moreover, because the pulling force is distributed over the shoulders 130 and over the lower torso 60 (or over the sternum 110), the pulling force is well distributed over the animal's body, minimizing any choking or any of the straps digging into the body of the animal due to the pressure concentrated at any one point.

To better accommodate the leash 125, a ring 135 is attached to the link 35 or to the loop 30 so that a leash 125 can be removably attached to the ring 135. One embodiment has the link 35 with a hole 140 formed at an end of the link 145, away from the front strap 20 and next to the closed loop 30. A part of the ring 135 is inserted through the hole 140 and the ring 135 is free to rotate about the hole 140.

Various versions of the harness 10 are available. An embodiment of the harness 10 for an animal 15 has a right strap 150 attached to the right extension 50 and a left strap 155 attached to the left extension 55. In this embodiment, a portion of the right extension 95 wraps around a torso 60 of the animal 15 and the right strap 150 attached to the right extension 50 is removably attached to the left tab 70, and a portion of the left extension 100 wraps around the torso 60 of the animal 15, crossing over or under the right extension 50, and the left strap 155 attached to the left extension 55 is removably attached to the right tab 65.

An embodiment of the harness 10 for an animal 15 has the right strap 150 with a right buckle 160 used to adjust length of the right strap 150 and the left strap 155 with a left buckle 165 used to adjust length of the left strap 155. The right buckle 160 and the left buckle 165 are used to adjust the harness 10 to comfortably fit the animal 15.

As shown in FIG. 1, another embodiment of the harness 10 for an animal may have a link 35 with an upper link 170 and a lower link 175. Having both the upper link 170 and the lower link 175 strengthens the overall strength of the link 35 while making the link 35 more flexible. Moreover, one end of the link 35 may cover an entire front strap width 180 of the front strap 20, and the other end of the link 35 may cover the entire rear strap width 185 of the closed loop 30. The overlapped area between the link and the front strap 20 and the overlapped area between the link 35 and the rear strap may be cross stitched to ensure that the link 35 does not tear off the front strap 20 or the rear strap 25.

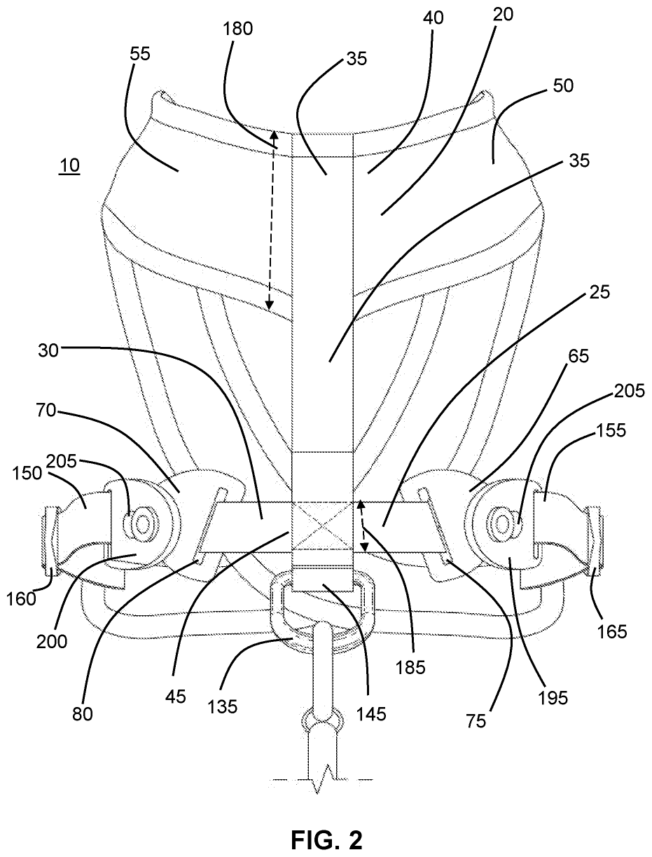

FIG. 2 shows a top view of the harness 10 for an animal 15. The right tab 65 and the left tab 70, each having a hooking protrusion 190, removably connecting to a left strap end 195 and a right strap end 200, respectively. The right strap end 200 is located on the right strap 150 and the left strap end 195 is located on the left strap 155, each right strap end 200 and the left strap end has an accommodating slot 205 to receive respective mating hooking protrusion 190. Although the hooking protrusions 190 are shown on the right tab 65 and the left tab 70, and the accommodating slots 205 are shown on the left strap end 195 and the right strap end 200, the placements of the hooking protrusions 190 and the strap ends 195, 200 may vary according to design choice. It should be noted that the hooking protrusions 190 may be located on the respective strap ends and the accommodating slots 205 may be located on the respective tabs 70. Moreover, as alternate attaching means such as hook and pile systems, buckles, buttons, snap on attachments, strings, and other commonly used removably fastening means may be used to replace hooking protrusions 190 and accommodating slots 205.

FIGS. 1-5 show the right extension 5 and the left extension 55 as padded and the right strap 150 and the left strap 155 are unpadded. The padded right extension 50 and the left extension 55 do not bind into the flesh of the animal 15 even when the animal is strong and require heavy pulling force to restrain the animal 15. The padded right extension 50 and the left extension 55, forming an “X” shape 105 over the sternum 110 of the animal 15 ensures that the pulling force is well dispersed over the sternum 100 and the section between the throat and the right front leg 85 (right shoulder) and the section between the throat and the left front leg 90 (left shoulder). The right strap 150 and the left strap 155 should be unpadded to better accommodate the right buckle 160 and the left buckle 165 adjusting the lengths for varying size animals 15.

While the description, drawings, and references have presented, shown, and described with reference to different embodiments thereof, it will be appreciated by those skilled in the art that variations in form, detail, compositions, and operation may be made without departing from the spirit and scope of the disclosure.

What is claimed is:

1. A harness for an animal comprising a front strap, a rear strap, and a link connecting an upper section of the front strap and an upper section of the rear strap,
wherein the front strap has a right extension and a left extension,
wherein the rear strap forms a closed loop,
wherein a right tab and a left tab are attached to the closed loop, and
wherein a portion of the right extension wraps around a torso of the animal to connect to the left tab when used on the animal, and a portion of the left extension wraps around the torso of the animal, crossing over or under the right extension and connect to the right tab when used on the animal.

2. The harness for an animal of claim 1,
wherein the right extension extends from the upper section of the front strap, covering over a section between a throat and a right front leg of the animal and continuing to also wrap around the torso of the animal to connect to the left tab when used on the animal, and
the left extension extends from the upper section of the front strap, covering over a section between the throat and a left front leg of the animal and continues to also wrap around the torso of the animal to connect to the right tab when used on the animal.

3. The harness for an animal of claim 2,
wherein the right tab and the left tab are slidably attached to the closed loop wherein either or both the right tab and the left tab slide along the closed loop.

4. The harness for an animal of claim 2,
wherein the right tab has a right tab opening and the left tab has a left tab opening so that the rear strap forming the closed loop is inserted through both the right tab opening and the left tab opening so that either or both the right tab and the left tab slide along the closed loop.

5. The harness for an animal of claim 4,
wherein the closed loop is flexible, able to have a varying loop width and a varying loop height.

6. The harness for an animal of claim 5,
wherein the portion of the right extension around the torso of the animal and the portion of the left extension around the torso of the animal cross over each other, forming an “X” shape, over a sternum of the animal.

7. The harness for an animal of claim 6,
wherein a ring is attached to the link or to the loop so that a leash can be attached to the ring.

8. The harness for an animal of claim 7,
wherein the link has a hole formed at an end of the link, away from the front strap and next to the closed loop, so a part of the ring is inserted through the hole and the ring is free to rotate about the hole.

9. A harness for an animal comprising a front strap, a rear strap, and a link connecting an upper section of the front strap and an upper section of the rear strap,
wherein the front strap has a right extension and a left extension,
wherein a right strap is attached to the right extension and a left strap is attached to the left extension,
wherein the rear strap forms a closed loop,
wherein a right tab and a left tab are attached to the closed loop, and
wherein a portion of the right extension wraps around a torso of the animal and the right strap attached to the right extension is removably attached to the left tab, and a portion of the left extension wraps around the torso of the animal, crossing over or under the right extension, and the left strap attached to the left extension is removably attached to the right tab.

10. The harness for an animal of claim 9,
wherein the right extension extends from the upper section of the front strap, covering over a section between a throat and a right front leg of the animal and continuing to also wrap around the torso of the animal, so the right strap is removably attached to the left tab when used on the animal, and
the left extension extends from the upper section of the front strap, covering over a section between the throat and a left front leg of the animal and continuing to also wrap around the torso of the animal, so the left strap is removably attached to the right tab when used on the animal.

11. The harness for an animal of claim 10,
wherein the right tab and the left tab are slidably attached to the closed loop wherein either or both the right tab and the left tab slide along the closed loop.

12. The harness for an animal of claim 10,
wherein the right tab has a right tab opening and the left tab has a left tab opening so that the rear strap forming the closed loop is inserted through both the right tab opening and the left tab opening so that either or both the right tab and the left tab slide along the closed loop.

13. The harness for an animal of claim 11,
wherein the closed loop is flexible, able to have a varying loop width and a varying loop height.

14. The harness for an animal of claim 12,
wherein the portion of the right extension around the torso of the animal and the portion of the left extension around the torso of the animal cross over each other, forming an “X” shape, over a sternum of the animal.

15. The harness for an animal of claim 13,
wherein a ring is attached to the link or to the loop so that a leash can be attached to the ring.

16. The harness for an animal of claim 14,
wherein the link has a hole formed at an end of the link, away from the front strap and next to the closed loop, so a part of the ring is inserted through the hole and the ring is free to rotate about the hole.

17. A harness for an animal comprising a front strap, a rear strap, and a link connecting an upper section of the front strap and an upper section of the rear strap,
wherein the front strap has a right extension and a left extension,
wherein a right strap is attached to the right extension and a left strap is attached to the left extension, and wherein the right strap has a right buckle used to adjust length of the right strap and the left strap has a left buckle used to adjust length of the left strap,
wherein the rear strap forms a closed loop,
wherein a right tab and a left tab are attached to the closed loop, and
wherein a portion of the right extension wraps around a torso of the animal and the right strap attached to the right extension is removably attached to the left tab, and a portion of the left extension wraps around the torso of the animal, crossing over or under the right extension, and the left strap attached to the left extension is removably attached to the right tab.

18. The harness for an animal of claim 17,
wherein the right extension extends from the upper section of the front strap, covering over a section between a throat and a right front leg of the animal and continuing to also wrap around the torso of the animal, so the right strap is removably attached to the left tab when used on the animal, and
the left extension extends from the upper section of the front strap, covering over a section between the throat and a left front leg of the animal and continuing to also wrap around the torso of the animal, so the left strap is removably attached to the right tab when used on the animal.

19. The harness for an animal of claim 18,
wherein the right tab has a right tab opening and the left tab has a left tab opening so that the rear strap forming the closed loop is inserted through both the right tab opening and the left tab opening so that either or both the right tab and the left tab slide along the closed loop,
wherein the closed loop is flexible, able to have a varying loop width and a varying loop height, and
wherein the portion of the right extension around the torso of the animal and the portion of the left extension around the torso of the animal cross over each other, forming an “X” shape, over a sternum of the animal.

20. The harness for an animal of claim 19,
wherein the link comprises of an upper link and a lower link and the link covers an entire front strap width of the front strap and an entire rear strap width of the closed loop.
